(19) United States
(12) Patent Application Publication
(10) Pub. No.: US 2023/0136329 A1
(43) Pub. Date: May 4, 2023

(54) TARGET DETECTION IN A POINT CLOUD

(71) Applicant: Emesent Pty Ltd, Milton (AU)

(72) Inventors: Hossein Ahmadzadeh, Bridgeman Downs (AU); David Prasser, Indooroopilly (AU); Timothy Greenfield, Milton (AU)

(21) Appl. No.: 17/975,019

(22) Filed: Oct. 27, 2022

(30) Foreign Application Priority Data
Oct. 28, 2021 (AU) 2021903451

(51) Int. Cl. G06T 7/73

(52) U.S. Cl. CPC G06T 7/73; G01S 17/10

(57) ABSTRACT

This disclosure relates to a method for locating a target in a point cloud. The point cloud comprises multiple coordinate points. The method is performed by a processor, which determines a candidate location of the target in the point cloud and calculates a score for the candidate location. The score is indicative of a match between a virtual shape of the target located at the candidate location and at least some of the multiple coordinate points. The processor then iteratively optimises the candidate location to improve the score to thereby improve the match and upon meeting a termination criterion, outputs the optimised candidate location as the location of the target in the point cloud.

### TECHNICAL FIELD

This disclosure relates to locating targets in a point cloud.

### BACKGROUND

Simultaneous localisation and mapping (SLAM) often relies on a point cloud that is generated based on Light Detection and Ranging (LIDAR) measurements. More particularly, a LIDAR sensor emits laser pulses and measures the time of flight to provide a distance from the sensor for various angles of the laser beam. Based on the current location of the sensor, these measurements can then be converted into a point cloud, which comprises multiple points and each point has a three-dimensional Cartesian coordinate. These points are therefore also referred to as coordinate points.

As a result, the point cloud resembles the three-dimensional structure of the environment of LIDAR sensor as far as it is visible by the sensor. In turn, this structure can be used by a SLAM algorithm to navigate and map autonomously, for example. The SLAM algorithm may be assisted by an inertial measurement unit (IMU). The IMU measures acceleration, which can be integrated to obtain current speed, which can again be integrated to obtain a translocation (change in location).

However, IMUs as well as SLAM algorithms suffer from drift, which means the point cloud becomes less accurate over time. For example, as an autonomous vehicle travels through an underground mine, the accuracy of the point cloud captured by a sensor mounted on the vehicle deteriorates as the vehicle travels through the mine. This is particularly problematic because no absolute reference, such as a global positioning system (GPS), is available. To provide absolute references, it is possible to place fixed targets into the underground mine. These fixed targets may have a geographic position determined by a surveyor. As a result, the accuracy is improved and may even be better than GPS in above-ground applications where GPS is available.

It is a problem, however, that it is difficult to automatically detect and locate the targets in the point cloud accurately considering the noise level of LIDAR (i.e. relative to LIDAR uncertainty). Further, a manual detection is cumbersome and time consuming. As a result, the determined location of the targets in the point cloud is often different to the actual location. This leads to an inaccurate point cloud when compared to the ground truth, that is, the actual real-world structure of the environment, such as the underground mine.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

There is provided a method for locating a target in a point cloud, the point cloud comprising multiple coordinate points. The method comprises:
determining a candidate location of the target in the point cloud;
calculating a score for the candidate location, the score being indicative of a match between a virtual shape of the target located at the candidate location and at least some of the multiple coordinate points;
iteratively optimising the candidate location to improve the score to thereby improve the match; and
upon meeting a termination criterion, outputting the optimised candidate location as the location of the target in the point cloud.

It is an advantage that the method optimises the candidate location to thereby improve the match between the shapes and the point cloud. That way the candidate location is more accurate compared to other methods, which means navigation and mapping using the accurate target in the point cloud is more accurate.

In some embodiments, each of the multiple coordinate points is associated with a measured return intensity and the method further comprises removing coordinate points that have a below threshold return intensity.

In some embodiments, the method further comprises clustering the multiple coordinate points in space to determine the at least some of the multiple coordinate points.

In some embodiments, the method further comprises clustering the multiple coordinate points in time to determine the at least some of the multiple coordinate points.

In some embodiments, the method further comprises projecting the at least some of the multiple coordinate points onto a two-dimensional plane before calculating the score.

In some embodiments, the target is a circular disk and the virtual shape of the target comprises points on a circle.

In some embodiments, the candidate location is a centre point of the circle.

In some embodiments, iteratively optimising the candidate location comprises performing multiple iterations of moving the candidate location and re-calculating the score.

In some embodiments, calculating the score comprises converting the at least some of the multiple coordinate points into polar coordinates and calculating the score based on angular sectors defined on the polar coordinates.

In some embodiments, calculating the score comprises determining a count of coordinate points that are within one of the angular sector and the score is based on the count.

In some embodiments, the method comprises a threshold count for sparse sectors to adjust the score to represent a worse match.

In some embodiments, the method comprises a threshold number for filled segments to adjust the score to represent a better match.

In some embodiments, the method comprises a deviation score based on a maximum difference between a coordinate location in a respective one of the angular sectors and the candidate location to adjust the score to represent a worse match.

In some embodiments, optimising the candidate location comprises performing a genetic algorithm.

In some embodiments, the genetic algorithm is based on individuals defined as two-dimensional coordinates of the candidate location and a size of the shape.

In some embodiments, optimising the candidate location comprises performing a grid search.

In some embodiments, the termination criterion is a maximum number of iterations.

In some embodiments, the method further comprises locating the same target multiple times in the point cloud and transforming the point cloud to align the candidate location of the multiple times the same target was located.

In some embodiments, the method further comprises rejecting a candidate location in response to the score indicating a match that is worse than a threshold.

Software, when executed by a computer, causes the computer to perform the above method.

A computer system for locating a target in a point cloud comprising:
data memory to store the point cloud comprising multiple coordinate points; and
a processor configured to:
   determine a candidate location of the target in the point cloud;
   calculate a score for the candidate location, the score being indicative of a match between a virtual shape of the target located at the candidate location and at least some of the multiple coordinate points;
   iteratively optimise the candidate location to improve the score to thereby improve the match; and
   upon meeting a termination criterion, output the optimised candidate location as the location of the target in the point cloud.

Optional features that have been described in relation to the method, are also optional features in relation to the computer system and software.

### BRIEF DESCRIPTION OF DRAWINGS

An example will now be described with reference to the following drawings:

FIG. 1 illustrates an example scenario including an unmanned aerial vehicle (UAV).

FIG. 2 graphically illustrates the resulting dataset of multiple points with the horizontal axis indicating distance from a LIDAR and the vertical axis indicating angle of direction.

FIG. 3 illustrates the dataset from FIG. 2 transformed to Cartesian coordinates.

FIG. 4 illustrates coordinate points of a point cloud in a three-dimensional Cartesian coordinate system.

FIG. 5 illustrates a target that is placed in the environment and located in the point cloud by the methods disclosed herein.

FIG. 6a illustrates again the dataset from FIG. 4 but now, a target has been placed into the scene.

FIG. 6b illustrates the result of intensity filtering of the dataset in FIG. 6a.

FIG. 6c illustrates the result of projecting the points from FIG. 6b onto a two-dimensional plane.

FIG. 6d illustrates the principle of an iterative process where the processor starts with a candidate location and iteratively optimises the candidate location until it arrives at an optimal solution.

FIG. 6e illustrates a clustering process.

FIG. 7 illustrates a method for locating a target in a point cloud.

FIG. 8a illustrates a cluster of points from a real-world experiment—projected onto a two-dimensional plane, intensity filtered, location clustered and time clustered.

FIG. 8b is a zoomed-in version of FIG. 8a.

FIG. 9 illustrates an example flight path of drone in top view and in side view for stope inspection and recommended layout of targets.

FIG. 10 illustrates a computer system for locating a target in a point cloud.

### DESCRIPTION OF EMBODIMENTS

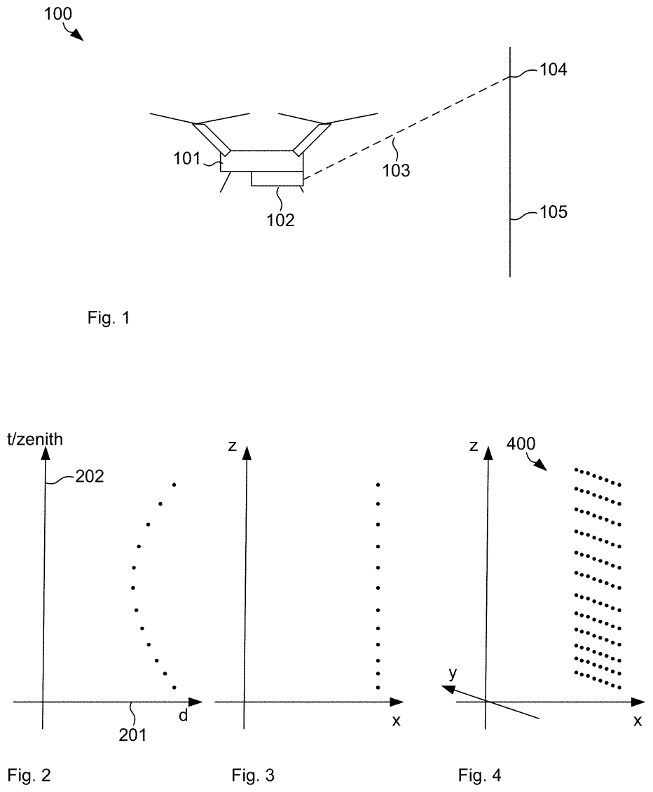

FIG. 1 illustrates an example scenario 100 including an unmanned aerial vehicle (UAV) or simply drone 101. Drone 101 is equipped with a LIDAR 102, which emits a laser pulse 103 and detects return light reflected from a point 104 on an object, such as a wall 105. LIDAR 102 measures the time difference between sending the laser pulse 103 and receiving the return light from point 104 and then calculates the distance of the point 104 from the LIDAR 102. LIDAR 102 records the calculated distance on data memory together with an angle of the direction of the laser pulse 103. LIDAR 102 repeats this process to obtain multiple distance measurements for multiple different angles of the direction of laser pulse 103. While FIG. 1 shows a drone as an example, other modes of movement equally work for the current disclosure, such as walking or movement by a land vehicle.

FIG. 2 graphically illustrates the resulting dataset of multiple points with the horizontal axis 201 indicating distance and the vertical axis 202 indicating angle of direction, which is the zenith angle in this example. It can be seen that the straight wall in FIG. 1 now appears curved simply because the points at the top of the wall 105 are further away from LIDAR 102 than points in the middle of the wall 105. More particularly, the distance describes a cosine function of the zenith angle.

A computer processor may now process the LIDAR data. That processor may be mounted on drone 101 or the data may be transmitted for off-line processing elsewhere.

In particular, the processor may apply an inverse cosine function to essentially transform the measurement points from a polar coordinate system into a Cartesian coordinate system. FIG. 3 illustrates the result of that transformation and now, the points in FIG. 3 are a straight line that resembles the actual shape of wall 105. The axes are now x- and z-axes, respectively. Repeating this process for multiple azimuth angles, i.e. left-right as opposed to up-down in FIGS. 1-3, results in a three-dimensional dataset 400, which is shown in FIG. 4. It is noted that there is now a third axis (the y-axis) and the points have already been converted to the Cartesian coordinate system as shown. The wall 105 now appears as a three-dimensional structure.

As the drone 101 moves through the environment, LIDAR 102 captures more data and gradually builds a three-dimensional dataset that represents the environment through which drone 101 has passed. The resulting set of points in three-dimensions is referred to as a “point cloud” 400. It is noted that a point cloud generally represents the environment and is therefore, a spatially sampled version of the visible surfaces of the environment. It is noted that as the drone 101 passes a particular object, LIDAR 102 captures that object multiple times as the drone 101 passes by. In other words, there is an overlap of samples from different points in time, depending on the speed of the drone. So, for example, a particular object may be scanned up to 100 times in a period of 10 s and all coordinates points overlap. It should also be noted that the points are not spaced regularly due to the mostly irregular movement of the drone. The process of registering the overlapping samples and forming a three-dimensional map of the environment is called SLAM. As a result, the coordinate points appear randomly distributed across the environment and it can be said that as the drone passes by, those coordinate points become more dense as LIDAR 102 keeps scanning the environment.

The point cloud may be stored in two-dimensions, or in polar coordinates or any other form. The points in the point cloud are therefore referred to as coordinate points.

While the captured data already enables a visual presentation of the environment in three dimensions, there are often inaccuracies that reduce usefulness of other applications. These inaccuracies relate to the exact location of the individually measured points as describe above and arising from inertial measurements or SLAM algorithms. The accuracy of the coordinate points can be improved by placing targets (also referred to as markers) into the environment.

### Target

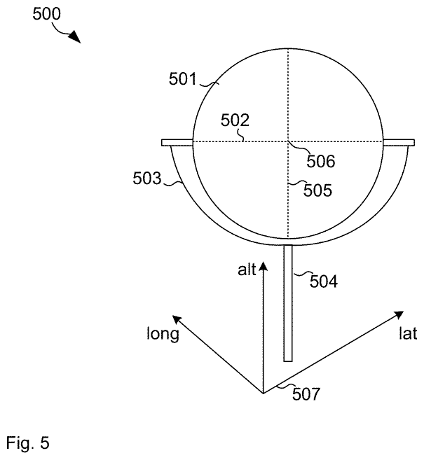

FIG. 5 illustrates an example target 500, comprising a reflective disk 501 mounted pivotably about a first rotation axis 502 on a gimbal 503. The reflective disk 501 may be of retro-reflective material, which means the material reflects light back to its source with minimum scattering, which is unlike a planar mirror. As a result, the intensity of the reflected light is higher than from a diffuse reflector, such as rock. The reflective disk 501 may have a radius of 125 mm or 175 mm or a different radius.

Gimbal 503 is mounted on a stem 504 pivotable about a second rotation axis 505. The specific location where centre 506 of target 500 is placed may be surveyed such that an absolute coordinate position of target 500 is known, which is indicated by an absolute coordinate system 507 comprising any conformal coordination system (e.g. latitude, longitude, altitude or Universal Transverse Mercator (UTM)), which is referred to as geo-referencing. This specific location may identify centre 506 of the disk 501. The distance between the centre 506 and the base of the stem 504 is fixed and known and does not change by rotation of the disk because the first rotation axis 502 and the second rotation axis 505 intersect at the centre point 506. As a result, the centre point 506 does not move when the disk is rotated.

It is now an aim to detect the target 500 in the point cloud so that the centre point 506 of the disk 501 is located in the point cloud. Then, the point cloud can be calibrated to the surveyed absolute coordinate position. It is also possible, without surveying the absolute position of the target, to improve accuracy where the target 500 is observed multiple times by the LIDAR. Due to the drift error, the target 500 may appear at different locations in the point cloud but has actually not moved. Therefore, the coordinates of the points in the point cloud can be corrected to essentially align the observed targets. This disclosure provides a method for accurately locating the centre 506 of the target 500 and thereby providing an accurate reference point for point cloud corrections.

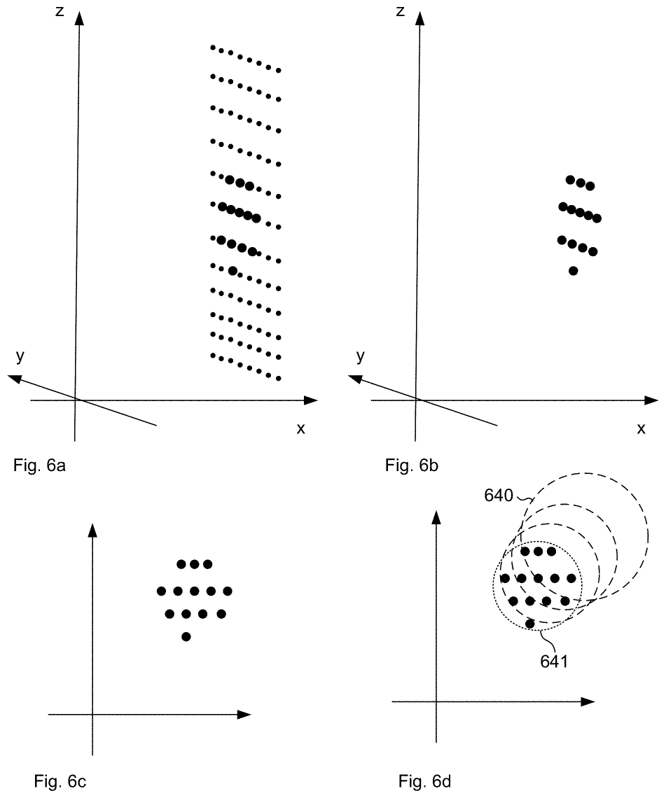

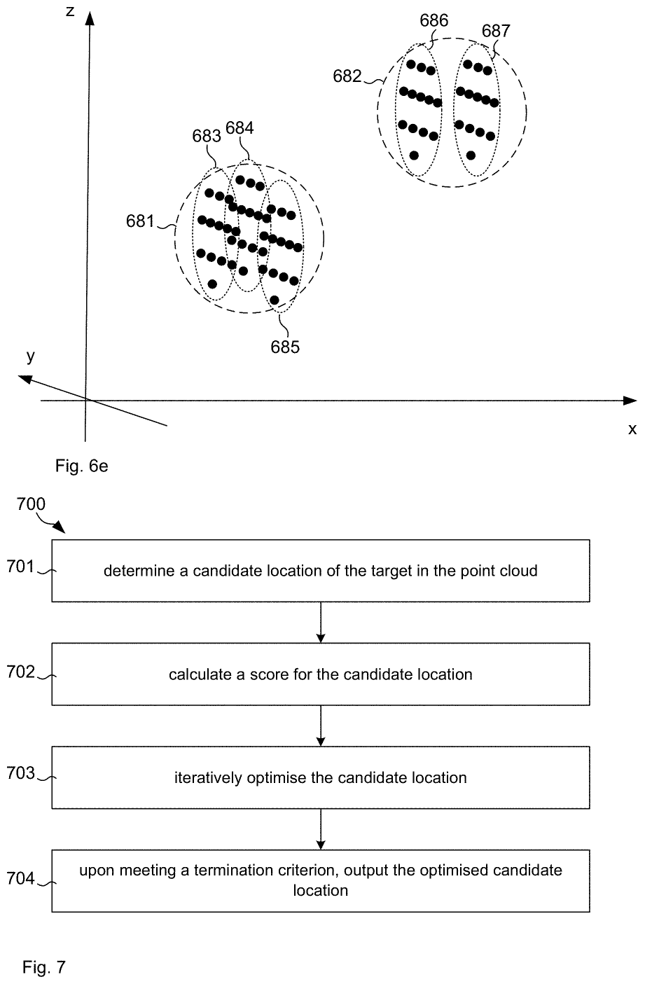

FIG. 6a illustrates again the dataset from FIG. 4 but now, target 500 has been placed into the scene. As set out above, the points shown in FIG. 6a do not necessarily come from a single rotation of the LIDAR but may have been acquired over a period of time when drone 101 passed the wall 105.

Further, LIDAR also measures the intensity of the reflected laser light. Since the retro-reflective surface produces a higher return light intensity, the points on the target 500 appear brighter in the point cloud. In FIG. 6a, this is indicated by the larger dots around the middle of the three-dimensional wall. It is now possible to apply an intensity filter to the point cloud, so that only points that originate from a retro-reflective surface remain in the point cloud and all other points, that are below the threshold are discarded. In one example, the intensity threshold is 150 (with a maximum intensity of 255). The result of the intensity filtering is shown in FIG. 6b, where the bright points form a ‘blob’.

There will likely be multiple blobs either because there are multiple targets or because the same target is observed multiple times. In order to differentiate between multiple observations of the same target, the processor first clusters the points by distance, so that points in each cluster are not far from their neighbours. Further, the processor applies a time clustering. For example, the processor may perform histogram clustering, that is, the processor computes a Gaussian kernel smoothed histogram of point cloud time distribution and then identifies time clusters within which observations have happened.

It is noted that each coordinate in the point cloud has a time value associated with it. The time value indicates the time at which this particular point has been generated. By time clustering the bright coordinate points, the processor can separate the different observations of the same target. That is, each cluster represents one blob.

FIG. 6e illustrates the clustering process. That is, compared to FIGS. 6a-6c, FIG. 6e illustrates a larger number of points that have been captured in the environment, noting that the points in FIG. 6e are after the intensity filter has removed lower intensity points. The first clustering step is a spatial neighbourhood clustering, which determines two clusters 681 and 682 that are spatially clearly separated. This could indicate that there is one target located near each of these clusters 681 and 682. However, it is possible that drone 101 passed by those targets multiple times, which is why the processor applies the time clustering. For the first spatial cluster 681, the time clustering results in three clusters 683, 684, and 685 to group points that were captured within a short time period. This example indicates that drone 101 passed the target three times and there is significant drift between these three passes. It can be seen that the three clusters spatially overlap. For most LIDAR applications this would be seen as a welcome increase in spatial resolution. Here, however, the time clustering separates the points from the multiple passes as indicated by the dotted ellipses. Similarly, spatial cluster 682 comprises two temporal clusters 686 and 687.

It is now an aim to process the points of an individual time cluster 683-687 to determine whether the cluster represents a target (or a number plate, for example) and to estimate the location, within the cluster of the centre point 506 of the target 500. One main idea is to determine whether the cluster represents a circular shape and then to find the most likely centre of that shape.

Since a circle is a two-dimensional object, but the point cloud is three-dimensional, the processor first projects the points (as shown in FIGS. 6b and 6e) of one cluster onto a two-dimensional plane resulting in the points shown in FIG. 6c. That plane may be found by optimising the plane parameters (origin and orientation of the plane's normal vector) so that the mean square distance between the points of the cluster and the plane is minimised.

It is now an aim to find a circle that best fits the two dimensional points shown in FIG. 6c. FIG. 6d illustrates the principle of an iterative process where the processor starts with a candidate location 640 including a candidate radius and iteratively optimises the candidate location and radius until it arrives at an optimal solution 641. It is noted that FIG. 6d only shows the circles for clarity and not the centre points, which are used as the actual candidate location herein. It can also be seen that the optimal candidate location is that where the shape of the target (i.e. circle) best matches the coordinate points of the cluster. So the proposed algorithm can be seen as a shape matching method, keeping in mind that LIDAR 102 may only see part of the target or only detect a small number of sample points, so the algorithm should be robust to partial occlusion and sparse observations. It is noted that the process of locating the target in the point cloud, is also referred to as target detection. Finally, it is the centre of the target that is used in later steps to correct drift in the point cloud or otherwise increase accuracy.

### Target Detection Method

FIG. 7 illustrates a method 700 for locating and determining the radius of target 500 in a point cloud 400. As described above, the point cloud 400 comprises multiple coordinate points. The method is typically performed by a computer processor. The processor determines 701 a candidate location of the target in the point cloud. This is an initial ‘guess’ and may be found by calculating the centre of gravity or simply the mean in x-direction and y-direction, respectively. The processor then calculates 702 a score for the candidate location and candidate radius. That score is indicative of a match between a virtual shape 640 of the target 500 (as defined by the candidate radius) located at the candidate location and at least some of the multiple coordinate points as shown in FIGS. 6c and 6d. As such, a high score may indicate a good match and the processor maximises the score or, alternatively, a low score may indicate a good match and the processor minimises the score.

The processor then iteratively optimises 703 the candidate location and radius to improve the score to thereby improve the match as shown by the multiple circles in FIG. 6d that each represent one iteration of the optimisation. More particularly, the processor moves the candidate location (i.e. calculates an updated value for x, y, and r) and re-calculates the score.

At each iteration, the processor tests whether a termination criterion has been met. Upon meeting the termination criterion, the processor outputs the optimised candidate location as the location of the target in the point cloud. Outputting the candidate location and radius may comprise storing the x,y location and r radius on computer memory, sending the location and radius as an electronic message or providing the location and radius to another algorithm, such as a SLAM algorithm or a point cloud transformation algorithm. For example, the transformation may be an elastic transformation that warps the point cloud such that the targets that are identified closely to each other, are aligned, that is, have their target centres at the same location in the point cloud after the transformation.

Before outputting the candidate location, the processor may test the best score achieved across all iterations against a threshold. Upon determining that the score does not meet the threshold, the processor rejects this cluster of points as a target. For example, the cluster of points may be from a number plate or from reflective clothing of a nearby worker. Therefore, a match between a circular shape and those points will not result in a sufficient matching score and as a result, the corresponding cluster is rejected.

### Target Detection Algorithm

In one example, the proposed target detection uses a fitness score to guide the optimization process towards finding an optimal centre and radius of the target represented by the point cloud. This fitness score is then used in a genetic algorithm (GA) or a Grid Search method for converging to an optimal location for the target centre and its radius.

### Fitness Score

The fitness score is evaluated for a circle located at (\hat{x}, ŷ) and radius r. The fitness score may be computed in the following steps:
1) Decompose the XY plane into N(B) radial bins or sectors (similar to pie slices but with rays going to infinity)
2) Translate points into a new coordinate frame with (\hat{x},ŷ) as origin
3) Convert point coordinates to polar with (\hat{x},ŷ) as origin
4) Determine membership of points to each bin or sector
5) Identify sparse bins/sectors and filled bins/sectors
6) Compute a deviation score for each bin/sector
7) Compute final fitness score as sum of deviation score, unfilled bins/sectors penalty, and sparse bins/sectors penalty

It is noted that having unfilled sectors as a penalty means that filled sectors adjust the score to represent a better match. Similarly, having a sparse sector penalty means that sparse sectors adjust the score to represent a worse match. The steps are summarized in Table 1 below.

TABLE 1

| SStep | Fitness Score Algorithm | Remarks |
|---|---|---|
| | Input: | N (.) length |
| | [symbol] (\hat{x}, ŷ),\hat{r} [symbol] : a circle centred at (\hat{x},ŷ) and radius \hat{r} | operator |
| | P = {pᵢ = (xᵢ, yᵢ)\|xᵢ, yᵢ ∈ [symbol] }: set of points on XY plane | Nₛₚₐᵣₛₑ controls |
| | N(B): number of bins | sensitivity of |
| | m ∈ [symbol] : minimum number of points to consider a bin non- | fitness score to |
| | sparse | the number of |
| | N_{sparse∈} [symbol] : number of allowed sparse bins | sparse bins |
| | Output: | |
| | A real-valued fitness score that specifies how well the | |
| | circle [symbol] (\hat{x}, ŷ), \hat{r} [symbol] is expressed by the points P. The smaller | |
| | fitness score, the better representation of circle by the | |
| | input points. | |
| I | Δb = 2π/N(B) | Δb bin size in |
| | B = {bᵢ = [−π + (i − 1) Δb], −π + i Δb], ∀i ∈ {1, . . . , N(B)}} | radians |
| | | B: set of bins |
| II | $\tilde{P} = \{ \begin{matrix}{\tilde{p}}_{i} = ( {\tilde{x}}_{i} , {\tilde{y}}_{i} ) \vert {\tilde{x}}_{i} = {x}_{i} - \hat{x} , \\ {\tilde{y}}_{i} = {y}_{i} - \hat{y} , i ∈ \{ 1 , … , N ( P ) \}\end{matrix} \}$ | update point coordinates around centroid |
| | | and convert their |
| III | Φ = {φᵢ = (\tilde{r}ᵢ, θᵢ)\|\tilde{r}ᵢ cos θᵢ = \tilde{x}ᵢ, \tilde{r}ᵢ sin θᵢ = \tilde{y}ᵢ, θᵢ ∈ [−π, π]}, | coordinates to |
| | ∀i ∈ {1, . . . , N(P)} | polar |
| IV | M(bᵢ) = {φⱼ\|L(bⱼ) ≤ θⱼ < ∈ U (bⱼ)}, ∀i ∈ {1, . . . , N(B)}, | M(bᵢ): set of |
| | ∀j ∈ {1, . . . , N(P)} | points belonging |
| | | to bᵢ |
| | | L(.): lower bound |
| | | operator |
| | | U(.): upper bound |
| | | operator |
| V | Bₛₚₐᵣₛₑ = {bᵢ∥M(bᵢ)\| < m}, ∀i ∈ {1, . . . , N(B)} | Bₛₚₐᵣₛₑ: set of |
| | B_{filled} = {bᵢ∥M(bᵢ)\| > 0}, ∀i ∈ {1, . . . , N(B)} | sparse bins |
| | | F: set of non- |
| | | empty (filled) bins |
| VI | D(bᵢ) = max{\tilde{r}ⱼ − \tilde{r}\|φⱼ ∈ M(bᵢ)} ∀i ∈ {1, . . . , N(B)}, | D(bᵢ): deviation |
| | ∀j ∈ {1, . . . , N(P)} | score for bᵢ |
| VII | $fitness = \frac{{\sum }_{i = 1}^{N ( B )} \vert D ( {b}_{i} ) \vert}{N ( {B}_{filled} )} + γ \frac{N ( B )}{N ( {B}_{filled} )} + ⌊ \frac{N ( {B}_{sparse} )}{{N}_{sparse}} ⌋$ | γ: (=0.005) penalty coefficient of unfilled bins. γ controls |
| | | sensitivity of |
| | | fitness score to |
| | | unfilled bins |

### Search Process

The processor employ a Genetic Algorithm or Grid Search algorithms to find an optimal location and radius of targets in order to match the virtual shape of the target in the point cloud to the clustered points in the point cloud.

### Genetic Algorithm

Individuals are defined as tuple [symbol] x, y, r [symbol] in which x and y are coordinates of target centre and r is the radius of target. Each individual parameter is defined over its own search space. Table 2 summarizes search space. GA parameters are configured as follows (but other configurations are also possible):
Mutation probability: 0.05
Crossover probability: 0.5
Population size: 150
Generations: 10
Threshold for GA best score for target detection: 0.040

TABLE 2
GA search space

| Search Space | Remarks |
|---|---|
| r∈ R | R: set of possible target radii = {0.125 m, |
| | 0.175 m} |
| x∈ X | X: Uniformly discretization from |
| | Σxᵢ/N(P) − max(r) to |
| | Σxᵢ/N(P) + max(r) into 10⁵ pieces |
| y∈ Y | Y: Uniformly discretization from |
| | Σyᵢ/N(P) − max(r) to |
| | Σyᵢ/N(P) + max(r) into 10⁵ pieces |

### Grid Search

Multiresolution grid search optimisation also is used for target centre detection when fast convergence is required.

The algorithm begins with an initial, inaccurate guess of the target centre and a list of radii, any of which the target is expected to have (e.g. in the case where there are two sizes of targets this list might be 0.125 m and 0.175 m).
1. Choose an initial grid spacing (for instance 10 mm).
2. Construct a two dimensional grid of evenly spaced XY coordinates of potential target centres, with the centre of the grid positioned at the location of the current guess.
3. Evaluate the target centre fitness score function at each of these XY locations for all expected target radii.
4. Determine which XY location and radius produced the minimum value of the cost function, this XY location is the new estimate of the target centre.
5. Reduce the grid spacing (eg from 10 mm to 1 mm) and go to step 2. Repeating until the grid spacing has reached the desired accuracy.

In one example, the processor uses two grid resolutions (10 mm and 1 mm). The advantage of multiple resolutions is a speed up—e.g. a single high resolution grid search could be conducted.

### Target Detection

In order to classify a set of points as target or not, the processor examines the optimal fitness score against a threshold value. If the score is smaller than threshold value, it is considered as a target with converged [symbol] x*, y*, r* [symbol] specification. Otherwise, the clustered points are classified as non-target.

### Outlier Removal

In order to improve robustness, the process may perform a method of statistical outlier removal (SOR), which computes first the average distance of each point to its neighbours (considering k nearest neighbours for each—k is the first parameter and an example value may be 11). Then it rejects the points that are farther than the average distance plus a number of times the standard deviation (second parameter and an example value may be 2.00).

The SOR filter may be applied multiple times during the process. For example, the SOR filter may be applied after the intensity filter and before the time clustering. The SOR filter may again be applied after the time clustering and then again for each time cluster.

### Constellation Graph

Once the target is located in the point cloud, the processor may generate a constellation graph. This is particularly useful in cases where more than one target is located in the environment. The constellation graph is a representation of the environment that is sampled only at the targets. In other words, the constellation graph has as many nodes as there are detected centre of targets. The remaining coordinate points in the point cloud are disregarded. Now, it is possible to align the constellation graph of one measurement to another constellation graph of a different measurement of the same environment. Aligning these constellation graphs then provides the transformation parameters that the processor can use to associate coordinate of each detected target in point cloud to coordinates of corresponding physical target in the environment. This associations can be used to transform the point cloud to improve the accuracy.

### Experiments

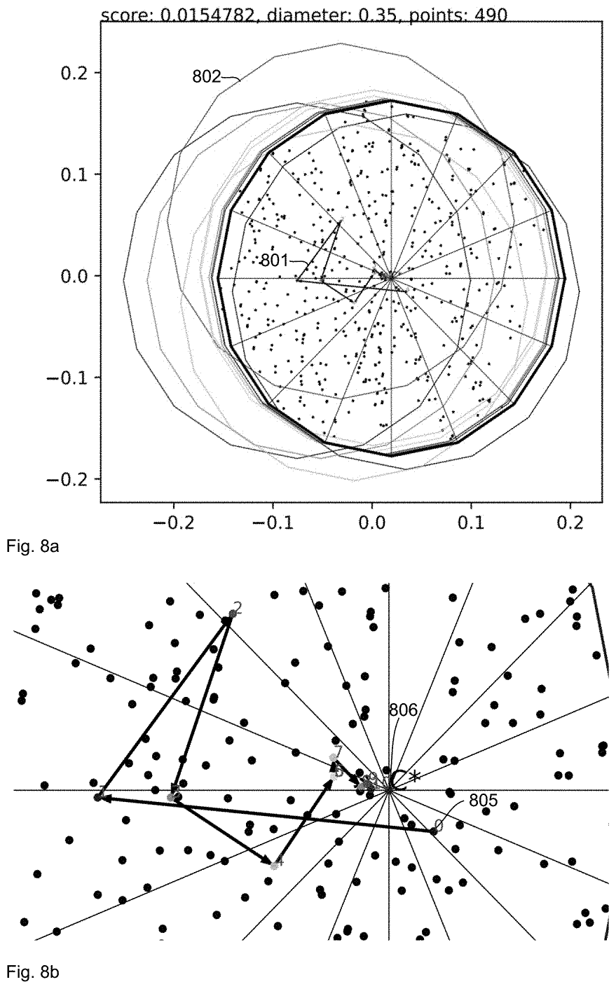

The methods disclosed herein have been tested on underground LIDAR data. FIG. 8a illustrates a cluster of 490 points. In this example, the processor has calculated a score of 0.0154782, noting that a lower score indicates a better match in this example. The figure also shows the candidate location and each iteration of the optimisation has moved the location along the polygonal chain 801. The virtual shape of the target, such as virtual shape 802 at initial location, are also shown. It is noted that the virtual shape is circular in the sense that multiple points of the shape are equidistant from the candidate location (i.e. the centre). These points define the ends of radii from the centre. However, the points between these end points, are not arcs of a circle but straight lines. That is, the virtual shapes 802 are approximations of, which means the virtual shape of the target is still circular.

FIG. 8b is a zoomed-in version of FIG. 8a that shows the path 801 more clearly from the initial candidate location 805 to the final optimise location 806. Here, C* is the optimal centre point and the optimal fitted disc is plotted in thick black line. The diagram is generated for 10 iteration as GA usually converges within 10 generations (with population of 150). The point cloud generated using the disclosed technique reached 5 mm accuracy while other approaches of using targets to enhance SLAM could reach an accuracy of 30 mm.

In one example, the parameters are as follows:

```
sor_filter:
  knn_radius: 11
  sigma_multiplier_threshold: 2.0
  iterations: 1
  sigma_iteration_multiplier: 2.0
planar_segmentation:
  min_inputs: 50
target_detector:
  plane_height_tolerance: 0.020
  radius: [0.125, 0.175]
  min_inputs: 50
  res: 16
  population: 150
  generations: 10
  minpoints_per_bin: 1
  sparse_bin_threshold: 1
  fitness_threshold: 0.040
```

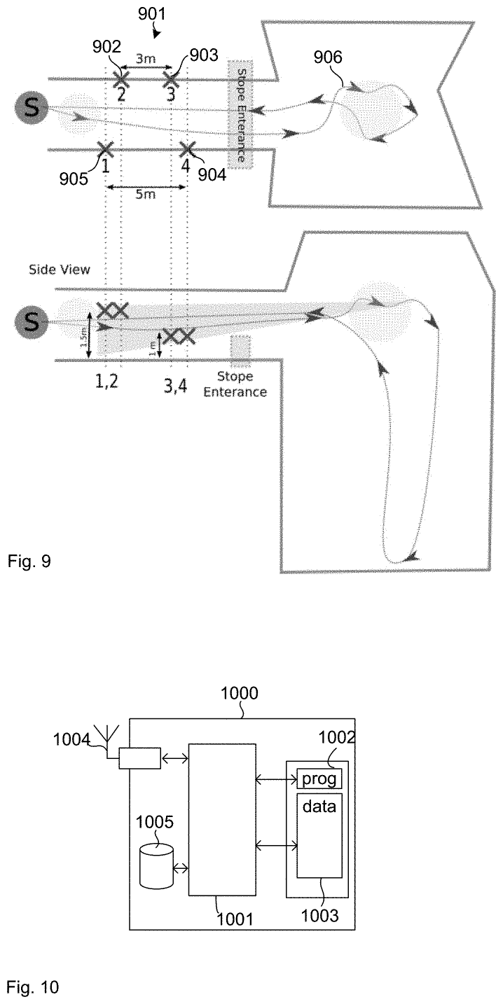

FIG. 9 illustrates an example target layout 901 comprising targets 902, 903, 904 and 905 and flight path 906 of drone 101 in top view and in side view for stope inspection. In this example, there are four targets 902-905 labelled as 1-4, which are located before the stope entrance. Even when the drone is in the stope, the targets 902-905 are visible at times, which is sufficient to improve accuracy of the point cloud representing the stope significantly.

### Computer System

FIG. 10 illustrates a computer system 1000 for locating a target in a point cloud. Computer system 1000 may be part of the payload of the drone 101 or may be located remotely for remote processing of LIDAR data. This is particularly beneficial when drone 101 does not need to autonomously navigate through unknown territory using SLAM but the main objective is the accurate point cloud after the flight is finished by a human operator.

The computer system 1000 comprises a processor 1001 connected to a program memory 1002, a data memory 1003, a communication port 1004. The program memory 1002 is a non-transitory computer readable medium, such as a hard drive, a solid state disk or CD-ROM. Software, that is, an executable program stored on program memory 1002 causes the processor 1001 to perform the method in FIG. 7, that is, processor 1001 determines a candidate location, calculates as score and optimises the candidate location. The term “determining a candidate location or score” refers to calculating a value that is indicative of the location or score. This also applies to related terms.

The processor 1001 may then store the optimised location on data store 1003, such as on RAM or a processor register. Processor 1001 may also send the determined location via communication port 1004 to a server, such as mine automation or management server.

The processor 1001 may receive data, such as LIDAR data, from data memory 1003 as well as from the communications port 1004. There may be a display that shows a visual representation of the three-dimensional environment after the correcting transformation to a user. In one example, the processor 1001 receives LIDAR data from LIDAR 102 via communications port 1004, such as by using a Wi-Fi network according to IEEE 802.11. The Wi-Fi network may be a decentralised ad-hoc network, such that no dedicated management infrastructure, such as a router, is required or a centralised network with a router or access point managing the network.

In one example, the processor 1001 receives and processes the LIDAR data in real time. This means that the processor 1001 determines the optimised location every time LIDAR data is received from LIDAR 102 and completes this calculation before the LIDAR send the next data update. The data may be batched or grouped so that the processor 1001 optimises the candidate location and corrects the point cloud at regular time intervals.

Although communications port 1004 is shown as a distinct entity, it is to be understood that any kind of data port may be used to receive data, such as a network connection, a memory interface, a pin of the chip package of processor 1001, or logical ports, such as IP sockets or parameters of functions stored on program memory 1002 and executed by processor 1001. These parameters may be stored on data memory 1003 and may be handled by-value or by-reference, that is, as a pointer, in the source code.

The processor 1001 may receive data through all these interfaces, which includes memory access of volatile memory, such as cache or RAM, or non-volatile memory, such as an optical disk drive, hard disk drive, storage server or cloud storage. The computer system 1000 may further be implemented within a cloud computing environment, such as a managed group of interconnected servers hosting a dynamic number of virtual machines.

FIG. 7 is to be understood as a blueprint for the software program and may be implemented step-by-step, such that each step in FIG. 7 is represented by a function in a programming language, such as C++ or Java. The resulting source code is then compiled and stored as computer executable instructions on program memory 1002.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for locating a target in a point cloud, the point cloud comprising multiple coordinate points, the method comprising:
determining a candidate location of the target in the point cloud;
calculating a score for the candidate location, the score being indicative of a match between a virtual shape of the target located at the candidate location and at least some of the multiple coordinate points;
iteratively optimising the candidate location to improve the score to thereby improve the match; and
upon meeting a termination criterion, outputting the optimised candidate location as the location of the target in the point cloud.

2. The method of claim 1, wherein each of the multiple coordinate points is associated with a measured return intensity and the method further comprises removing coordinate points that have a below threshold return intensity.

3. The method of claim 1, wherein the method further comprises clustering the multiple coordinate points in space to determine the at least some of the multiple coordinate points.

4. The method of claim 1, wherein the method further comprises clustering the multiple coordinate points in time to determine the at least some of the multiple coordinate points.

5. The method of claim 1, wherein the method further comprises projecting the at least some of the multiple coordinate points onto a two-dimensional plane before calculating the score.

6. The method of claim 1, wherein the target is a circular disk and the virtual shape of the target comprises points on a circle.

7. The method of claim 6, wherein the candidate location is a centre point of the circle.

8. The method of claim 1, wherein iteratively optimising the candidate location comprises performing multiple iterations of moving the candidate location and re-calculating the score.

9. The method of claim 1, wherein calculating the score comprises converting the at least some of the multiple coordinate points into polar coordinates and calculating the score based on angular sectors defined on the polar coordinates.

10. The method of claim 9, wherein calculating the score comprises determining a count of coordinate points that are within one of the angular sector and the score is based on the count.

11. The method of claim 10, wherein the method comprises a threshold count for sparse sectors to adjust the score to represent a worse match.

12. The method of claim 9, wherein the method comprises a threshold number for filled segments to adjust the score to represent a better match.

13. The method of claim 9, wherein the method comprises a deviation score based on a maximum difference between a coordinate location in a respective one of the angular sectors and the candidate location to adjust the score to represent a worse match.

14. The method of claim 1, wherein optimising the candidate location comprises performing a genetic algorithm.

15. The method of claim 14, wherein the genetic algorithm is based on individuals defined as two-dimensional coordinates of the candidate location and a size of the shape.

16. The method of claim 1, wherein optimising the candidate location comprises performing a grid search.

17. (canceled)

18. The method of claim 1, wherein the method further comprises locating the same target multiple times in the point cloud and transforming the point cloud to align the candidate location of the multiple times the same target was located.

19. The method of claim 1, wherein the method further comprises rejecting a candidate location in response to the score indicating a match that is worse than a threshold.

20. A non-transitory, computer readable medium with program code stored thereon that, when executed by a computer, causes the computer to perform the method of claim 1.

21. A computer system for locating a target in a point cloud, the computer system comprising:
data memory to store the point cloud comprising multiple coordinate points; and
a processor configured to:
determine a candidate location of the target in the point cloud;
calculate a score for the candidate location, the score being indicative of a match between a virtual shape of the target located at the candidate location and at least some of the multiple coordinate points;
iteratively optimise the candidate location to improve the score to thereby improve the match; and
upon meeting a termination criterion, output the optimised candidate location as the location of the target in the point cloud.
